(19) United States
(12) Patent Application Publication
(10) Pub. No.: US 2011/0197085 A1
(43) Pub. Date: Aug. 11, 2011

(54) POWER LINE COMMUNICATION DEVICE

(75) Inventor: KUN-YI WU, Tu-Cheng (TW)

(73) Assignee: HON HAI PRECISION INDUSTRY CO., LTD., Tu-Cheng (TW)

(21) Appl. No.: 12/844,833

(22) Filed: Jul. 28, 2010

(30) Foreign Application Priority Data
Feb. 6, 2010 (CN) 201010301289.2

(51) Int. Cl. G06F 1/26

(52) U.S. Cl. 713/323

(57) ABSTRACT

A power line communication (PLC) device is connected to a television power line to detect a working state of a television. When the television is turned off, the PLC device notifies a set-top box to enter a standby mode via a main power line. When the television is turned on, the PLC device notifies the set-to box to enter a normal working mode via the main power line.

### BACKGROUND

1. Technical Field

Embodiments of the present disclosure relate to power line communications, and more particularly to a power line communication device.

2. Description of Related Art

People are transitioning from analog television systems to digital television systems. These digital television systems often include set-top boxes. Accordingly, the set-top boxes are popular in many cities, and provide digital television services for users.

However, users often forget to turn off the set-top boxes connected to the televisions when the televisions are switched off. Thus, the set-top boxes often work to waste power when they are not being used.

### BRIEF DESCRIPTION OF THE DRAWINGS

The details of the disclosure, both as to its structure and operation, can best be understood by referring to the accompanying drawing, in which like reference numbers and designations refer to like elements.

FIG. 1 is a schematic diagram of an application environment of a power line communication (PLC) device in accordance with the present disclosure;

FIG. 2 is a schematic diagram showing a connection relation of the PLC device of FIG. 1;

FIG. 3 is a circuit diagram of one embodiment of a PLC device in accordance with the present disclosure;

FIG. 4 is a flowchart showing the PLC device of FIG. 3 notifying a set-top box to enter a standby mode in accordance with the present disclosure; and

FIG. 5 is a flowchart showing the PLC device of FIG. 3 notifying a set-top box to enter a normal working mode in accordance with the present disclosure.

### DETAILED DESCRIPTION

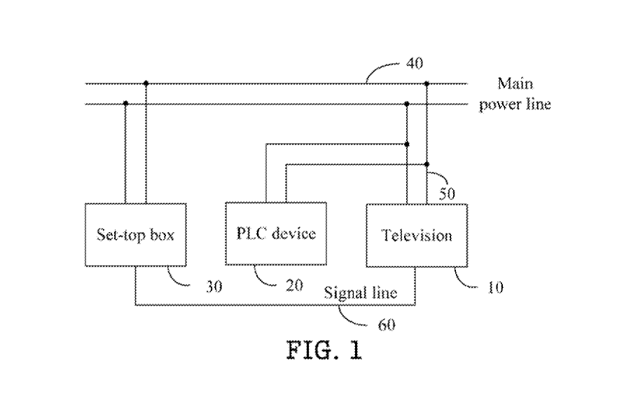

FIG. 1 is a schematic diagram of an application environment of a power line communication (PLC) device 20 in accordance with the present disclosure. In one embodiment, a television 10 is connected to a main power line 40 via a television power line 50 to acquire power from the main power line 40. The PLC device 20 is connected to the television power line 50 to detect working modes of the television 10. A set-top box 30 is connected to the main power line 40 to acquire power from the main power line 40. The television 10 is further connected to the set-top box 30 via a signal line 60 to receive television programs from the set-top box 30.

In one embodiment, the PLC device 20 controls working modes of the set-top box 30 according to working states of the television 10. The working modes of the set-top box 30 include a standby mode and a normal working mode. The set-top box 30 in the standby mode consumes less power than the set-top box 30 in the normal working mode. The working states of the television 10 include the television 10 being turned on and off. When the television 10 is turned off, the PLC device 20 notifies the set-top box 30 to enter the standby mode via the main power line 40. When the television 10 is turned on, the PLC device 20 notifies the set-top box 30 to enter the normal working mode via the main power line 40. Thus, the set-top box 30 consumes power when needed, and accordingly power consumption is reduced.

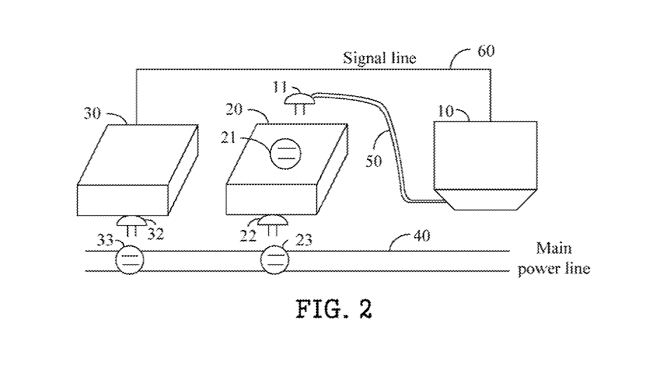

FIG. 2 is a schematic diagram showing a connection relation of the PLC device 20 of FIG. 1. In one embodiment, the PLC device 20 may be an adapter, and includes a socket 21 and a plug 22. The socket 21 of the PLC device 20 receives a plug 11 of the television 10. The plug 22 of the PLC device 20 is inserted into a socket 23 of the main power line 40. A plug 32 of the set-top box 30 is inserted into a socket 33 of the main power line 40. Additionally, the television 10 is connected to the set-top box 30 via the signal line 60.

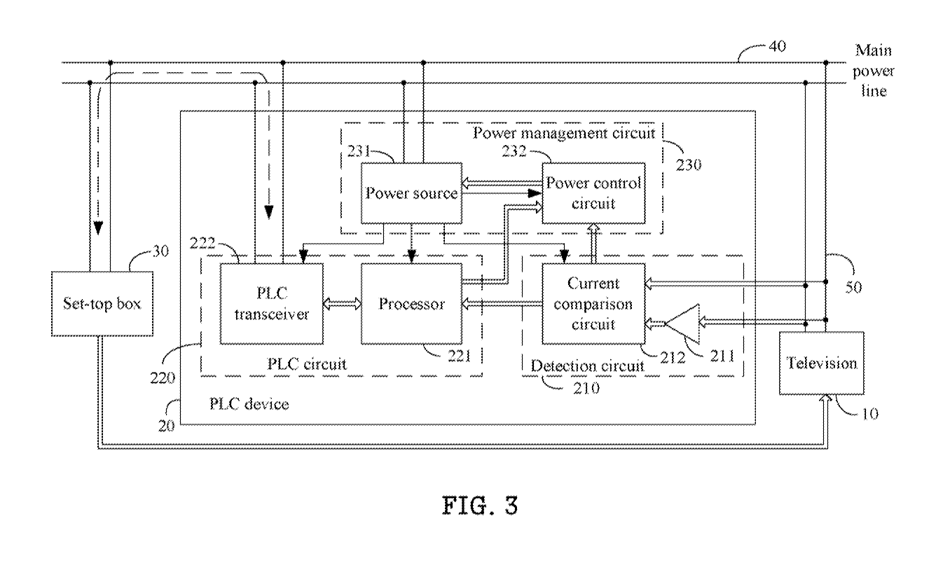

FIG. 3 is a circuit diagram of one embodiment of the PLC device 20 in accordance with the present disclosure. Single solid lines and arrowed single lines indicate power supply lines, arrowed double lines indicate data transmission lines, and arrowed broken lines indicate a data transmission direction.

In one embodiment, the PLC device 20 includes a detection circuit 210, a PLC circuit 220, and a power management circuit 230.

The detection circuit 210 is connected to the television power line 50 to detect a working state of the television 10. The detection circuit 210 transmits a power-off notification signal to the PLC circuit 220 when the television 10 is turned off, and transmits a power-on triggering signal to the power management circuit 230 when the television 10 is turned on.

The PLC circuit 220 is connected to the detection circuit 210 to receive the power-off notification signal from the detection circuit 210 and transmit a first notification packet to the set-top box 30 to notify the set-top box 30 to enter a standby mode. In one embodiment, the set-top box 30 receives the first notification packet from the PLC circuit 220, and then knows that the television 10 has been turned off according to the first notification packet. Accordingly, the set-top box 30 automatically enters the standby mode and transmits a first acknowledgement packet to the PLC device 20 to indicate that the set-top box 30 has entered the standby mode. Thus, the PLC circuit 220 receives the first acknowledgement packet from the set-top box 30 to acknowledge that the set-top box 30 has entered the standby mode, and then transmits a power-off triggering signal to the power management circuit 230 according to the first acknowledgement packet.

The power management circuit 230 is operable to acquire power from the main power line 40 and continuously supply power to the detection circuit 210. The power management circuit 230 is further operable to stop supplying power to the PLC circuit 220 after the power-off triggering signal is received from the PLC circuit 220, and start to supply power to the PLC circuit 220 after the power-on triggering signal is received from the detection circuit 210.

The PLC circuit 220 is further operable to transmit a second notification packet to the set-top box 30 to notify the set-top box 30 to enter a normal working mode after power is supplied from the power management circuit 230. In one embodiment, the set-top box 30 receives the second notification packet from the PLC circuit 220, and then knows that the television 10 has been turned on according to the second notification packet. Accordingly, the set-top box 30 automatically enters the normal working mode and transmits a second acknowledgement packet to the PLC device 20 to indicate that the set-top box 30 has entered the normal working mode. Thus, the PLC circuit 220 receives the second acknowledgement packet from the set-top box 30 to acknowledge that the set-top box 30 has entered the normal working mode.

In one detailed embodiment, the detection module 210 includes a delay buffer 211 and a current comparison circuit 212. The delay buffer 211 is connected to the television power line 50 to receive a first current signal from the television power line 50 at a first time and delay the first current signal to a second current signal. As used herein, “current signal” denotes a flow of electric charge. The current comparison circuit 212 is connected to the television power line 50 and the delay buffer 21. The current comparison circuit 212 is operable to receive a third current signal from the television power line 50 and the second current signal from the delay buffer 211 at a second time. The current comparison circuit 212 further compares the third current signal with the second current signal to determine the working state of the television 10. In one example, a difference between the first time and the second time may be 10 ms.

When the third current signal is greater than the second current signal and a difference between the third current signal and the second current signal is greater than a predetermined value, the current comparison circuit 212 determines that the television 10 is turned on. In one example, the predetermined value may be a current value of 1A.

When the third current signal is smaller than the second current signal and the difference between the third current signal and the second current signal is greater than the predetermined value, the current comparison circuit 212 determines that the television 10 is turned off.

The current comparison circuit 212 is further operable to transmit the power-off notification signal to the PLC circuit 220 when the television 10 is turned off, and transmit the power-on triggering signal to the power management circuit 230 when the television 10 is turned on.

In one detailed embodiment, the PLC circuit 220 includes a processor 221 and a PLC transceiver 222. The processor 221 is connected to the current comparison circuit 212 to receive the power-off notification signal from the current comparison circuit 212 and generate the first notification packet according to the power-off notification signal. The processor 221 is further operable to generate the second notification packet after power is supplied from the power management circuit 230.

The PLC transceiver 222 is connected to the processor 221 to receive the first notification packet from the processor 221, transmit the first notification packet to the set-top box 30, and receive the first acknowledgement packet from the set-top box 30. The PLC transceiver 222 is further operable to receive the second notification packet from the processor 221, transmit the second notification packet to the set-top box 30, and receive the second acknowledgement packet from the set-top box 30.

The processor 221 is further operable to receive the first acknowledgement packet from the PLC transceiver 222, acknowledge that the set-top box 30 has entered the standby mode according to the first acknowledgement packet, and then transmit the power-off triggering signal to the power management circuit 230. The processor 221 is further operable to receive the second acknowledgement packet from the PLC transceiver 222 and acknowledge that the set-top box 30 has entered the normal working mode according to the second acknowledgement packet.

In one detailed embodiment, the power management circuit 230 includes a power control circuit 232 and a power source 231. The power control circuit 232 is connected to the current comparison circuit 212 to receive the power-on triggering signal from the current comparison circuit 212 and transmit a power-on control signal to the power source 231 according to the power-on triggering signal. The power control circuit 232 is connected to the processor 221 to receive the power-off triggering signal from the processor 221 and transmit a power-off control signal to the power source 231 according to the power-off triggering signal.

The power source 231 is connected to the main power line 40 to acquire power from the main power line 40. The power source 231 is connected to the current comparison circuit 212 and the power control circuit 232 to continuously supply power to the current comparison circuit 212 and the power control circuit 232. The power source 231 is connected to the PLC transceiver 222 and the processor 221, and operable to stop supplying power to the PLC transceiver 222 and the processor 221 when the power-off control signal is received from the power control circuit 232, and start to supply power to the PLC transceiver 222 and the processor 221 when the power-on control signal is received from the power control circuit 232.

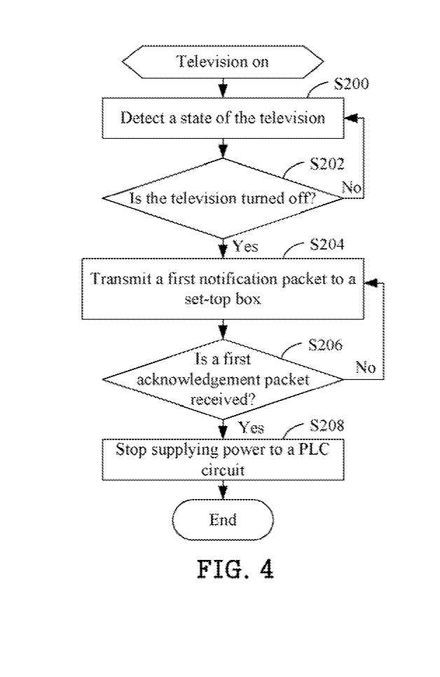

FIG. 4 is a flowchart showing the PLC device 20 of FIG. 3 notifying the set-top box 30 to enter a standby mode in accordance with the present disclosure.

Initially, the television 10 is on.

In block S200, the detection circuit 210 detects a working state of the television 10.

In block S202, the detection circuit 210 determines whether the television 10 is turned off.

If the television 10 is not turned off, going back to block S200, the detection circuit 210 continues to detect the working state of the television 10.

If the television 10 is turned off, the PLC circuit 220 transmits a first notification packet to the set-top box 30 to notify the set-top box 30 to enter a standby mode as shown in block S204.

In one embodiment, if the set-top box 30 receives the first notification packet, the set-top box 30 knows that the television 10 has been turned off. Accordingly, the set-top box 30 automatically enter the standby mode and transmits a first acknowledgement packet to the PLC device 20 to indicate that the set-top box 30 has entered the standby mode.

In block S206, the PLC circuit 220 determines whether the first acknowledgement packet is received from the set-top box 30.

If the first acknowledgement packet is not received from the set-top box 30, going back to block S204, the PLC circuit 220 continues to transmit the first notification packet to the set-top box 30.

If the first acknowledgement packet is received from the set-top box 30, the power management circuit 230 stops supplying power to the PLC circuit 220 as shown in block S208. That is, the PLC device 20 enters to a power saving mode.

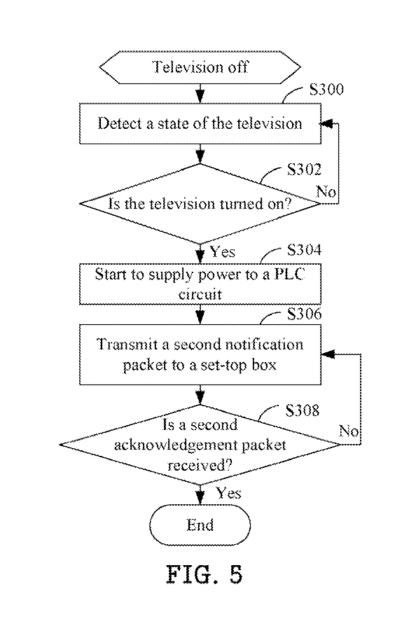

FIG. 5 is a flowchart showing the PLC device of FIG. 3 notifying the set-top box 30 to enter a normal working mode in accordance with the present disclosure.

Initially, the television 10 is off.

In block S300, the detection circuit 210 detects a working state of the television 10.

In block S302, the detection circuit 210 determines whether the television 10 is turned on.

If the television 10 is not turned on, going back block S300, the detection circuit 210 continues to detect the working state of the television 10.

If the television 10 is turned on, the power management circuit 230 starts to supply power to the PLC circuit 220 as shown in block S304.

In block S306, the PLC circuit 220 transmits a second notification packet to the set-top box 30 to notify the set-top box 30 to enter a normal working mode.

In one embodiment, if the set-top box 30 receives the second notification packet, the set-top box 30 knows that the television 10 has been turned on. Accordingly, the set-top box 30 automatically enters the normal working mode and transmits a second acknowledgement packet to the PLC device 20 to indicate that the set-top box 30 has entered the normal working mode.

In block S308, the PLC circuit 220 determines whether the second acknowledgement packet is received from the set-top box 30.

If the second acknowledgement packet is not received from the set-top box 30, going back to block S306, the PLC circuit 220 continues to transmit the second notification packet to the set-top box 30 until receiving the second acknowledgement packet.

In general, the PLC device 20 notifies the set-top box 30 to enter a standby mode via the main power line 40 when the television 10 is turned off, and notifies the set-top box 30 to enter a normal working mode via the main power line 40 when the television 10 is turned on. Thus, the set-top box 30 is avoided working for too long time, and power consumption is reduced.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A power line communication (PLC) device for controlling working modes of a set-top box according to working states of a television, the television being connected to a main power line via a television power line to acquire power from the main power line, the PLC device comprising:
a detection circuit connected to the television power line to detect a working state of the television, and transmit a power-off notification signal when the television is turned off, or transmit a power-on triggering signal when the television is turned on;
a PLC circuit operable to receive the power-off notification signal from the detection circuit and transmit a first notification packet to the set-top box to notify the set-top box to enter a standby mode, and operable to receive a first acknowledgement packet from the set-top box to acknowledge that the set-top box has entered the standby mode and transmit a power-off triggering signal according to the first acknowledgement packet;
a power management circuit operable to acquire power from the main power line and continuously supply power to the detection circuit, and operable to stop supplying power to the PLC circuit after the power-off triggering signal is received from the PLC circuit, and start to supply power to the PLC circuit after the power-on triggering signal is received from the detection circuit;
wherein the PLC circuit is further operable to transmit a second notification packet to the set-top box to notify the set-top box to enter a normal working mode after power is supplied from the power management circuit, and receive a second acknowledgement packet from the set-top box to acknowledge that the set-top box has entered the normal working mode.

2. The PLC device of claim 1, wherein the detection module comprises:
a delay buffer connected to the television power line to receive a first current signal from the television power line at a first time, and delay the first current signal to a second current signal; and
a current comparison circuit connected to the television power line and the delay buffer, operable to receive a third current signal from the television power line and the second current signal from the delay buffer at a second time, and compare the third current signal with the second current signal to determine the working state of the television, and operable to transmit the power-off notification signal to the PLC circuit when the television is turned off, and transmit the power-on triggering signal to the power management circuit when the television is turned on.

3. The PLC device of claim 2, wherein the current comparison circuit determines that the television is turned on when the third current signal is greater than the second current signal and a difference between the third current signal and the second current signal is greater than a predetermined value, and determines that the television is turned off when the third current signal is smaller than the second current signal and the difference between the third current signal and the second current signal is greater than the predetermined value.

4. The PLC device of claim 2, wherein the PLC circuit comprises:
a processor operable to receive the power-off notification signal from the current comparison circuit and generate the first notification packet according to the power-off notification signal, and operable to generate the second notification packet after power is supplied from the power management circuit; and
a PLC transceiver connected to the processor, operable to receive the first notification packet from the processor, transmit the first notification packet to the set-top box, and receive the first acknowledgement packet from the set-top box, and operable to receive the second notification packet from the processor, transmit the second notification packet to the set-top box, and receive the second acknowledgement packet from the set-top box;
wherein the processor is further operable to receive the first acknowledgement packet from the PLC transceiver, acknowledge that the set-top box has entered the standby mode according to the first acknowledgement packet, and then transmit the power-off triggering signal to the power management circuit, and operable to receive the second acknowledgement packet from the set-top box and acknowledge that the set-top box has entered the normal working mode according to the second acknowledgement packet.

5. The PLC device of claim 4, wherein the power management circuit comprises:
a power control circuit connected to the current comparison circuit and the processor, operable to receive the power-on triggering signal from the current comparison circuit, and transmit a power-on control signal according to the power-on triggering signal, and operable to receive the power-off triggering signal from the processor, and transmit a power-off control signal according to the power-off triggering signal;
a power source connected to the main power line, the power control circuit, the current comparison circuit, the processor, and the PLC transceiver, operable to acquire power from the main power line, continuously supply power to the current comparison circuit and the power control circuit, stop supplying power to the PLC transceiver and the processor when the power-off control signal is received from the power control circuit, and start to supply power to the PLC transceiver and the processor when the power-on control signal is received from the power control circuit.

6. The PLC device of claim 1, further comprising a plug and a socket, wherein the plug of the PLC device is inserted into a socket of the main power line, and a socket of the PLC device receives a plug of the television.
